(19) United States
(12) Patent Application Publication
(10) Pub. No.: US 2021/0225157 A1
(43) Pub. Date: Jul. 22, 2021

(54) Smart Relay Car Alarm System

(71) Applicant: James Raymer, Jonesboro, GA (US)

(72) Inventor: James Raymer, Jonesboro, GA (US)

(21) Appl. No.: 17/155,456

(22) Filed: Jan. 22, 2021

Related U.S. Application Data
(60) Provisional application No. 62/964,197, filed on Jan. 22, 2020.

(51) Int. Cl. G08B 25/00; B60R 25/10; B60R 25/102; B60R 25/33

(52) U.S. Cl. CPC G08B 25/009; B60R 25/33; B60R 25/102; B60R 25/1004

(57) ABSTRACT

A smart relay vehicle alarm system is shown and described. The smart relay vehicle alarm system includes a first sensor, such as a microphone, installed upon a vehicle. The first sensor is electrically coupled to a microcontroller. The microcontroller can send a signal via a wireless transceiver to an associated mobile device when the first sensor is activated. In one embodiment, the smart relay vehicle alarm system includes a monitoring system. The wireless transceiver will send the signal to the monitoring system instead of the associated mobile device. The monitoring system will forward a signal to the associated mobile device when the first sensor is triggered via a vehicle alarm.

### CROSS REFERENCE TO RELATED APPLICATIONS

This application claims the benefit of U.S. Provisional Application No. 62/964,197 filed on Jan. 22, 2020. The above identified patent application is herein incorporated by reference in its entirety to provide continuity of disclosure.

### BACKGROUND OF THE INVENTION

The present invention relates to car alarm systems. More particularly, the present invention provides an installable relay system that works with an existing car alarm to notify an individual of a break-in, or similar event, while the individual is not within the audible range of the existing car alarm.

Currently, almost all modern vehicles are equipped with basic car alarm systems. Traditionally, these car alarms are triggered when a lock is forced opened or the alarm otherwise detects unauthorized attempted access to the vehicle. When the alarm is triggered, the car has an audible sound which is often sourced from the vehicle horn. The horns usually sound similar o other vehicle horns. Further, these horns only have a limited range from which they may be heard.

Since these car alarms only have a limited amount of warning range and because the alarms are only triggered in a limited set of events, many times the alarms do not provide any security. In some instances, alarms are not heard and thus the owner is not alerted to any issue. In other instances, the alarms are not triggered at all giving individuals time to steal items from the vehicle.

Consequently, there is a need for an improvement in the art of vehicle alarms. The present invention substantially diverges in design elements from the known art while at the same time solves a problem many people face when a vehicle is broken into and the owner is not within hearing distance of the alarm. In this regard the present invention substantially fulfills these needs.

### SUMMARY OF THE INVENTION

The present invention provides a smart relay car alarm system wherein the same can be utilized for providing convenience for the user when they are out of hearing range of the traditional car alarm. The smart relay vehicle alarm system is comprised of a first sensor installed in a vehicle. The first sensor is designed to sense the car alarm of the vehicle on which the first sensor is installed. The first sensor is electrically coupled to a microcontroller. The microcontroller is configured to send a signal via a wireless transceiver to an associated mobile device.

Another object of the smart relay vehicle alarm system is to have the wireless transceiver send the signal to a monitoring system instead of the associated mobile device. The monitoring system will forward a signal to the associated mobile device when the first sensor is triggered via a vehicle alarm.

Another object of the smart relay vehicle alarm system is to have the first sensor be an audible sensor.

Another object of the smart relay vehicle alarm system is to have the first sensor be a glass breaking sensor.

Another object of the smart relay vehicle alarm system is to have an electrical cord configured to plug into a vehicles cigarette lighter port, providing power to the system.

Another object of the smart relay vehicle alarm system is to have a second sensor located within the cabin of the vehicle.

Another object of the smart relay vehicle alarm system is to have the second sensor be a glass break sensor.

Another object of the smart relay vehicle alarm system is to have the associated mobile device display a vehicle alarm notification when the signal is received.

Another object of the smart relay vehicle alarm system is to have the first sensor placed adjacent to the horn of a motor vehicle.

Another object of the smart relay vehicle alarm system is to have the first sensor positioned adjacent the horn of the motor vehicle such that the first sensor is not physically connected or implemented with the existing alarm system.

Another object of the smart relay vehicle alarm system is to have the first sensor connected to an existing circuitry of the existing alarm system of the vehicle.

Another object of the smart relay vehicle alarm system is to have the monitoring system notify the proper local authorities of the vehicle alarm.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a wiring diagram of an embodiment of the smart relay car alarm system.

FIG. 2 shows a perspective view of an embodiment of the location of the sensors for the smart relay car alarm system.

FIG. 3 shows perspective view of an embodiment of the location of the smart relay car alarm system from within the vehicle cab.

FIG. 4A shows a flow chart of an embodiment of how the system functions.

FIG. 4B shows a flow chart of an embodiment of how the system functions.

### DETAILED DESCRIPTION OF THE INVENTION

Reference is made herein to the attached drawings. Like reference numerals are used throughout the drawings to depict like or similar elements of the smart relay car alarm system. For the purposes of presenting a brief and clear description of the present invention, a preferred embodiment will be discussed as used for the smart relay car alarm system. The figures are intended for representative purposes only and should not be considered to be limiting in any respect.

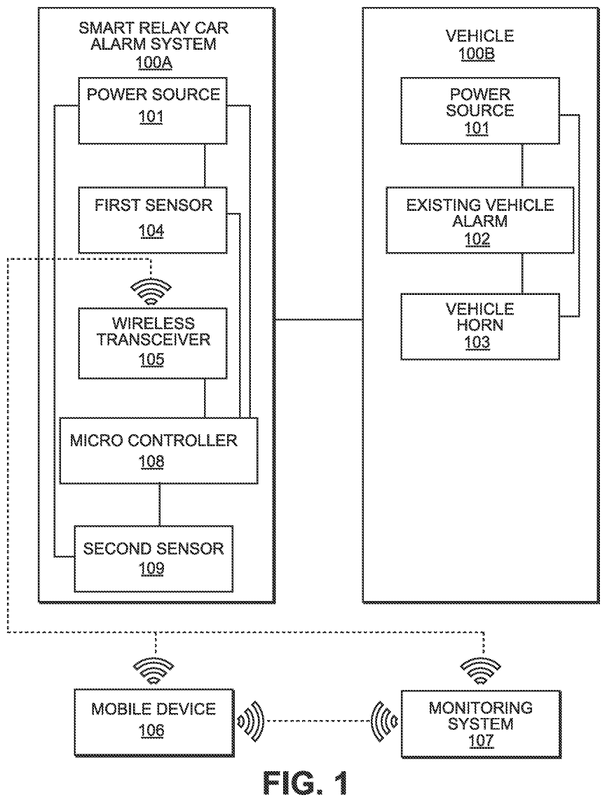

Referring now to FIG. 1, there is shown a wiring diagram of an embodiment of the smart relay car alarm system. The smart relay car alarm system 100A is a separate system integrated with an existing vehicle 100B. In some embodiments, the smart relay car alarm system 100A and the existing vehicle 100B share parts. The smart relay car alarm system 100A includes a power source 101. In one embodiment, the power source 101 is a vehicle battery. In this embodiment, the vehicle battery will not be drained which could prevent the vehicle from starting. In one embodiment, the power source 101 is a combination of the existing car battery and a separate battery for the system.

Ideally, the power source 101 will be separated from the existing vehicle 100B. Furthermore, there may be a complete absence of wired or physical connections between the smart relay car alarm system 100A and the existing vehicle 100B. As such, the smart relay car alarm system 100A may be installed or implemented upon any vehicle, regardless of the specific make or model.

The power source 101 is operably coupled to the existing vehicle alarm 102. The existing vehicle alarm 102 will activate if the locks of the vehicle 100B are tampered with. The existing vehicle alarm 102 is coupled to the vehicle horn 103. The vehicle horn 103 is coupled to the power source 101 in the embodiment where the power source 101 is the vehicle battery. When the existing vehicle alarm 102 is activated, the existing vehicle horn 103 will sound.

In one embodiment, a first sensor 104 is operably coupled to the power source 101. In one embodiment, the first sensor 104 is an audible sensor, such as a microphone. In another embodiment, the first sensor 104 is a glass breaking sensor. The first sensor 104 is placed adjacent to the vehicle horn 103 such that the first sensor 104 will detect the sound from a vehicle horn 103. Ideally, the first sensor 104 is not connected to the existing vehicle alarm 102 by any physical or tangible means.

A microcontroller 108 is further coupled to the power source 101. The microcontroller 108 is operably coupled to the first sensor 104 and a wireless transceiver 105. The wireless transceiver 105 is configured to send wireless signals to an external receiver. In one embodiment, the external receiver is a mobile device 106. In another embodiment, the external receiver is a monitoring system 107. In one embodiment, the monitoring system 107 is part of a monitoring company.

In another embodiment, the smart relay car alarm system 100A includes a second sensor 109. The second sensor 109 is electrically coupled to the power source 101. In one embodiment, the second sensor 109 is operably coupled to the existing vehicle alarm 102, In another embodiment the second sensor 109 is operably coupled to the microcontroller 108.

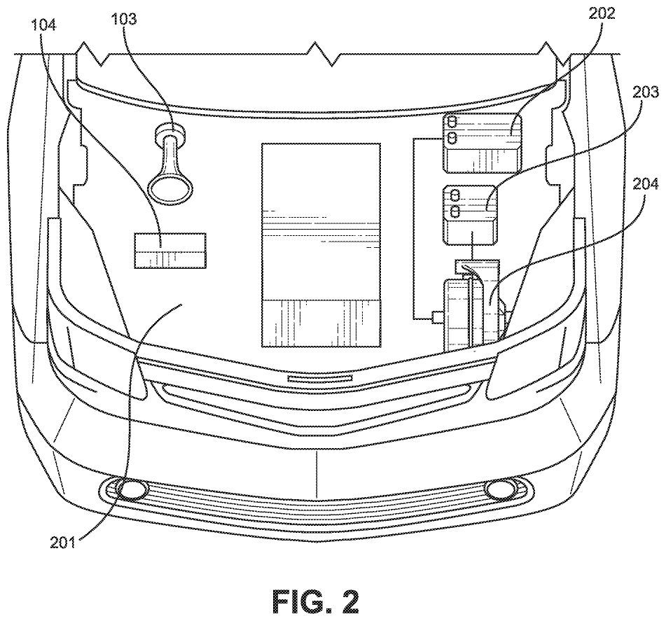

Referring now to FIG. 2, there is shown a perspective view of an embodiment of the location of the sensors for the smart relay car alarm system. In one embodiment, the first sensor 104 is located in the vehicle engine bay 201. In one embodiment, the first sensor 104 is located adjacent to the vehicle horn 103, In the embodiment, where the first sensor 104 is a glass breaking sensor, this will allow the first sensor 104 to only be triggered when the vehicle horn 103 is activated. This is because glass breaking sensors are operated by vibration. The vibrations required will only allow the first sensor 104 to be triggered by strong sound waves. This means that the further away sounds are produced, the less likely it is for the first sensor 104 to be falsely triggered. Alternatively, the first sensor 104 may comprise a sensitivity adjustment mechanism, such as a switch or knob, that allows the sensitivity of the first sensor 104 to be adjustable.

Further, in the shown embodiment there is shown the existing vehicle battery 202. There is also shown a second battery 203. These batteries 202, 203 make up the power source 101. In this embodiment, both batteries 202, 203 are operably coupled to the vehicle alternator 204. This will allow for both batteries 202, 203 to be charged when the vehicle is activated.

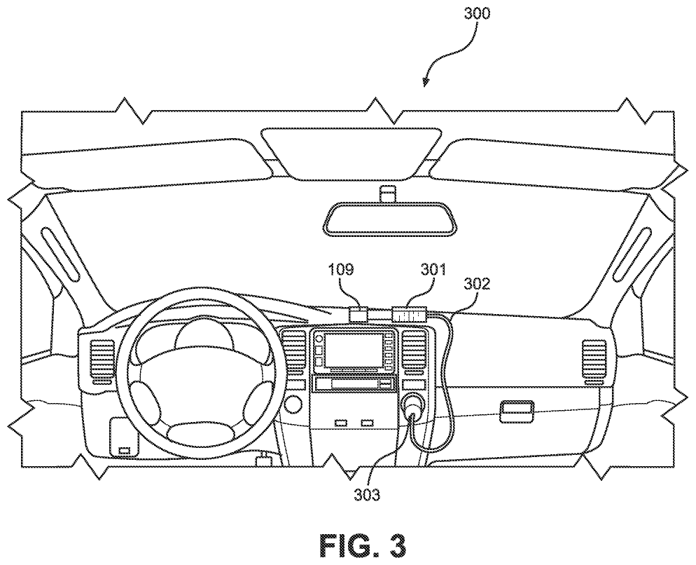

Referring now to FIG. 3, there is shown perspective view of an embodiment of the location of the smart relay car alarm system from within the vehicle cab. In one embodiment the second sensor 109 is located within the cabin of a vehicle 300. In one embodiment the second sensor 109 is a glass breaking sensor. The second sensor 109 is operably placed to detect when vehicle glass is broken. In one embodiment, the second sensor 109 is operably coupled to the existing vehicle alarm. This will allow for the existing vehicle alarm to be improved. In another embodiment, the second sensor 109 is coupled to the smart relay car alarm system.

In one embodiment, the smart relay car alarm system includes a housing 301 located within the vehicle cab 300. The housing 301 includes a base, having at least one sidewall, and a top section. The housing 301 includes an interior volume to house various components as shown and described in FIG. 1. In one embodiment, the housing 301 has an electrical cord 302 extending therefrom and in connection with the interior volume. In one embodiment the electrical cord 302 is configured to connection to a vehicle cigarette lighter port 303.

In one embodiment, the housing 301 contains the microcontroller and the wireless transceiver. The electrical cord 302 is electrically coupled to both the microcontroller and the wireless transceiver. This will allow an individual to unplug the system and therefore deactivate it as desired. Further, in this embodiment only one wire will have to be installed through the dash firewall of a vehicle. In this embodiment, only the first sensor will have to be installed within the vehicle engine bay.

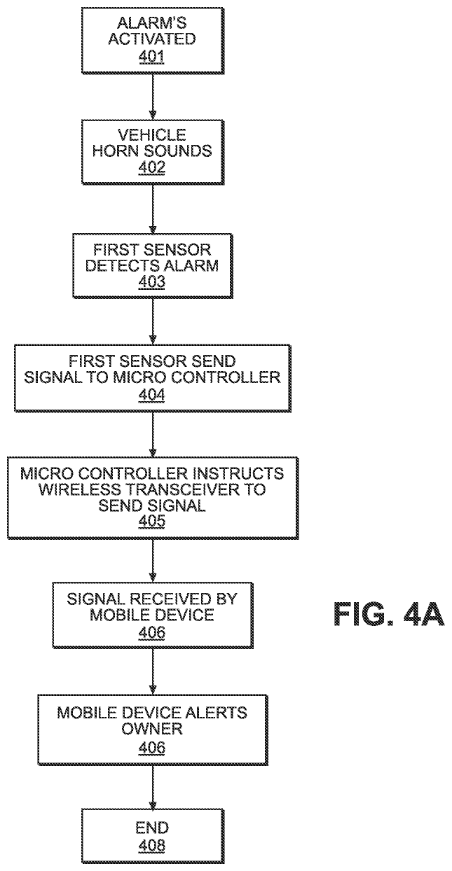

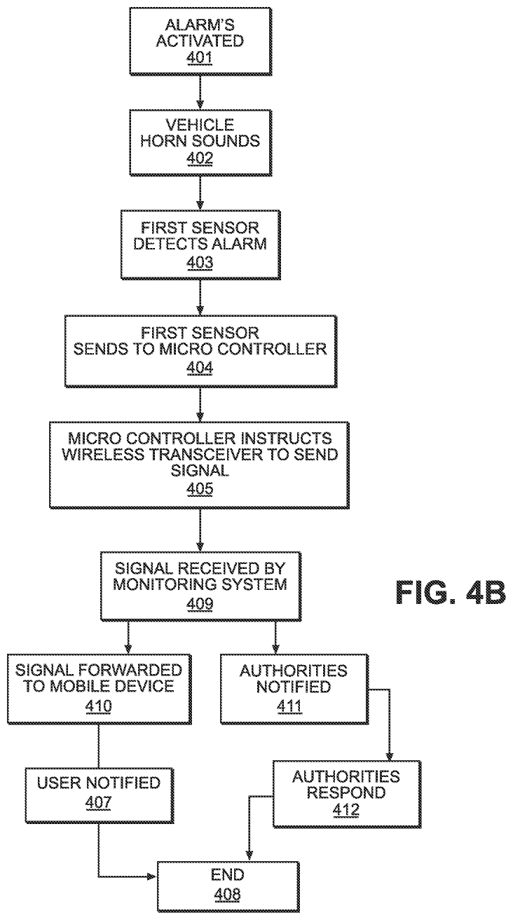

Referring now to FIG. 4A and FIG. 4B, there are shown flow charts of embodiments of how the system functions. In both embodiments, the system starts when an alarm is activated 401. In one embodiment, the alarm is activated 401 because the existing locks are tampered with. In another embodiment, the alarm is activated because the second sensor registers glass has been broken.

Once the alarm has been activated 401, the vehicle horn will sound 402. The first sensor, using audible sensing, will detect the activated alarm via the vehicle horn 403. The first sensor will send a signal to the microcontroller 404. The microcontroller will then instruct the wireless transceiver to send an alarm signal 405. Now referring only to FIG. 4A, the wireless signal is received by a designated mobile device 406. The designated mobile device will alert the owner of the vehicle alarm 407. At this point the method will end 408.

Referring now only to FIG. 4B, the wireless signal is received by a designated monitoring system 409. The monitoring system will then forward the received signal to the designated mobile device 410. In one embodiment the monitoring system will also notify the local authorities of the alarm 411. The designated mobile device will alert the owner of the vehicle alarm 407. In many embodiments the authorities will respond to the alarm 412. At this point, the method will end 408.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A smart relay vehicle alarm system, the system comprises:
a first sensor installed upon a vehicle;
the first sensor is electrically coupled to a microcontroller;
the microcontroller is configured to send a signal via a wireless transceiver to an associated mobile device when the first sensor is triggered via a vehicle alarm.

2) The smart relay vehicle alarm system of claim 1, wherein the first sensor is an audible sensor.

3) The smart relay vehicle alarm system of claim 1, wherein the first sensor is a glass breaking sensor.

4) The smart relay vehicle alarm system of claim 1, further comprising an electrical cord configured to plug into a vehicles cigarette lighter port, providing power to the system.

5) The smart relay vehicle alarm system of claim 1, further comprising a second sensor located within the cabin of the vehicle.

6) The smart relay vehicle alarm system of claim 5, wherein the second sensor is a glass breaking sensor.

7) The smart relay vehicle alarm system of claim 1, wherein the associated mobile device will display a vehicle alarm notification when the signal is received.

8) The smart relay vehicle alarm system of claim 1, wherein the first sensor is placed adjacent to the horn of a motor vehicle.

9) The smart relay vehicle alarm system of claim 1, wherein the first sensor is connected to an existing circuitry of the existing alarm system of the vehicle.

10) A smart relay vehicle alarm system, the system comprises:
a first sensor operably coupled to a vehicle;
the first sensor is electrically coupled to a microcontroller;
the first sensor comprising a microphone;
the microcontroller is configured to send a signal via a wireless transceiver to a monitoring system;
the monitoring system will forward a signal to an associated mobile device when the first sensor is triggered via a vehicle alarm.

11) The smart relay vehicle alarm system of claim 10, wherein the first sensor is a glass breaking sensor.

12) The smart relay vehicle alarm system of claim 10, further comprising an electrical cord configured to plug into a vehicles cigarette lighter port, providing power to the system.

13) The smart relay vehicle alarm system of claim 10, further comprising a second sensor located within the cabin of the vehicle.

14) The smart relay vehicle alarm system of claim 13, wherein the second sensor is a glass breaking sensor.

15) The smart relay vehicle alarm system of claim 10, wherein the associated mobile device will display a vehicle alarm notification when the signal is received.

16) The smart relay vehicle alarm system of claim 10, wherein the first sensor is placed adjacent to the horn of a motor vehicle.

17) The smart relay vehicle alarm system of claim 10, wherein the monitoring system notifies the proper local authorities of the vehicle alarm.
